(19) United States
(12) Patent Application Publication
(10) Pub. No.: US 2017/0061359 A1
(43) Pub. Date: Mar. 2, 2017

(54) System and Method of Assigning Maintenance Services

(71) Applicant: Caterpillar Inc., Peoria, IL (US)

(72) Inventor: Robert Bullock, Germantown Hills, IL (US)

(21) Appl. No.: 14/842,166

(22) Filed: Sep. 1, 2015

(51) Int. Cl. G06Q 10/06

(52) U.S. Cl. CPC G06Q 10/063114

(57) ABSTRACT

A method of assigning maintenance services for a fleet of machines is disclosed. The method may include storing a list of maintenance services for the fleet of machines in the electronic maintenance tracking database, and displaying, via a computing device, the list of maintenance services for the fleet of machines. The method may further include displaying an option to assign a maintenance service for a machine. The method may further include receiving input from an administrator, via the computing device, to assign the maintenance service, and prompting the administrator to select a technician to perform the maintenance service. The method may further include storing in the electronic maintenance tracking database data associated with the selected technician in connection with the maintenance service and the machine. The method may further include communicating data associated with the maintenance service and the machine to a portable computing device associated with the selected technician.

### FIELD OF THE DISCLOSURE

The present disclosure relates generally to earthmoving machines and, more particularly, to systems and methods for assigning maintenance services for earthmoving machines.

### BACKGROUND OF THE DISCLOSURE

Machines, such as earthmoving and construction machines, may require periodic inspections or maintenance services in order to ensure proper performance during operation. Accordingly, owners, dealers, manufacturers, inspectors, and technicians of machines use various electronic systems to track these periodic maintenance services. Many different electronic systems may organize and store data relating to a fleet of machines, along with the type of maintenance services that have been completed or need to be completed.

However, these electronic systems do not have the capability to assign the overdue or upcoming maintenance services to particular technicians. More specifically, current electronic tracking systems may track maintenance services, but users or administrators of current electronic tracking systems must use another system, such as, a second separate electronic system, to assign a specific maintenance service for a certain machine to a particular technician. This entails the administrator having to relay machine data and maintenance service data by hand into the second system that notifies the particular technician.

For example, the administrator may have to handwrite said data on a piece of paper and enter said data into the second system that notifies the particular technician. In addition, when the assigned maintenance service is completed, the administrator has to enter in completion of the maintenance service to the electronic tracking system by hand in order to update its database. Thus, there exists a need for a single electronic system that can both track and assign maintenance services, as well as integrate administrator activity and technician activity into one fluid and visible interface.

A system for facilitating vehicle inspection is disclosed in U.S. Pat. No. 6,052,631, entitled, “Method and System for Facilitating Vehicle Inspection to Detect Previous Damage and Repairs. The inspection facilitator system of the '631 patent includes an inspection engine, an inspection user interface, and one or more data repositories for storing vehicle-related and inspection-related information. Furthermore, the inspection engine of the '631 patent sends inspection instructions to the inspection user interface, which then directs the inspection of a vehicle by a technician or by an apparatus.

While effective, there is still a need for methods and systems that integrate assignment of maintenance services with the overall maintenance tracking of the machine within the fleet of machines.

### SUMMARY OF THE DISCLOSURE

In accordance with one embodiment, a method of assigning maintenance services for a fleet of machines using a maintenance tracking computer server associated with an electronic maintenance tracking database is disclosed. The method may include storing a list of maintenance services for the fleet of machines in the electronic maintenance tracking database, and displaying, via a computing device, the list of maintenance services for the fleet of machines. The method may further include displaying, via the computing device, an option to assign a maintenance service for a machine.

The method may further include receiving input from an administrator, via the computing device, to assign the maintenance service, and prompting the administrator, via the computing device, to select a technician to perform the maintenance service. The method may further include storing in the electronic maintenance tracking database data associated with the selected technician in connection with the maintenance service and the machine. The method may further include communicating data associated with the maintenance service and the machine to a portable computing device associated with the selected technician.

In accordance with another embodiment, a system of assigning maintenance services for a fleet of machines is disclosed. The system may include an electronic maintenance tracking database and a maintenance tracking computer server linked to the electronic maintenance tracking database. The maintenance tracking computer server may include a processor configured via computer-executable instructions to store a list of maintenance services for the fleet of machines in the electronic maintenance tracking database. The processor may be further configured to display the list of maintenance services, and display an option to assign a selected maintenance service for a selected machine.

The processor may be further configured to receive input from an administrator to assign the selected maintenance service, and display an option to assign a technician to complete the selected maintenance service upon receiving input from the administrator to assign the selected maintenance service. The processor may be further configured to receive input from the administrator indicating the assigned technician to complete the selected maintenance service for the selected machine, and store data associated with the assigned technician in connection with the selected maintenance service and the selected machine in the electronic maintenance tracking database. The processor may be further configured to transmit data associated with the selected maintenance service and the selected machine to a portable computing device associated with the assigned technician.

In accordance with yet another embodiment, a method of assigning maintenance services for a fleet of machines using a maintenance tracking computer server associated with an electronic maintenance tracking database is disclosed. The method may include electronically writing a tracking list for the fleet of machines to the electronic maintenance tracking database, the tracking list including a plurality of maintenance services to be completed for each of the machines. The method may further include displaying the tracking list via a first computing device, and displaying an option to assign each of the maintenance services via the first computing device. The method may further include receiving input from an administrator to assign a selected maintenance service for a selected machine via the first computing device.

The method may further include displaying a prompt to the administrator, via the first computing device, to select a technician to complete the selected maintenance service for the selected machine. The method may further include receiving from the administrator, via the first computing device, data associated with the selected technician to complete the selected maintenance service for the selected machine. The method may further include generating an updated tracking list based on the data associated with the selected technician in connection with the selected maintenance service for the selected machine. The method may further include storing the updated tracking list in the electronic maintenance tracking database, and transmitting data associated with the selected maintenance service and the selected machine to a second computing device associated with the selected technician.

These and other aspects and features will become more readily apparent upon reading the following detailed description when taken in conjunction with the accompanying drawings. In addition, although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a schematic representation of a maintenance tracking system, in accordance with one embodiment of the present disclosure;

FIG. 2 is an architectural layout of the maintenance tracking system of FIG. 1;

FIG. 3 is a side view of a machine, in accordance with another embodiment;

FIG. 4 is a schematic view of a tracking list interface available to an administrator of the maintenance tracking system of FIG. 1;

FIG. 5 is a flow diagram with example interfaces illustrating an assignment feature of the maintenance tracking system of FIG. 1;

FIG. 6 is a schematic view of a technician assignment interface available to an administrator of the maintenance tracking system of FIG. 1; and

FIG. 7 is a flowchart illustrating an example process for assigning maintenance services for a fleet of machines, in accordance with another embodiment.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

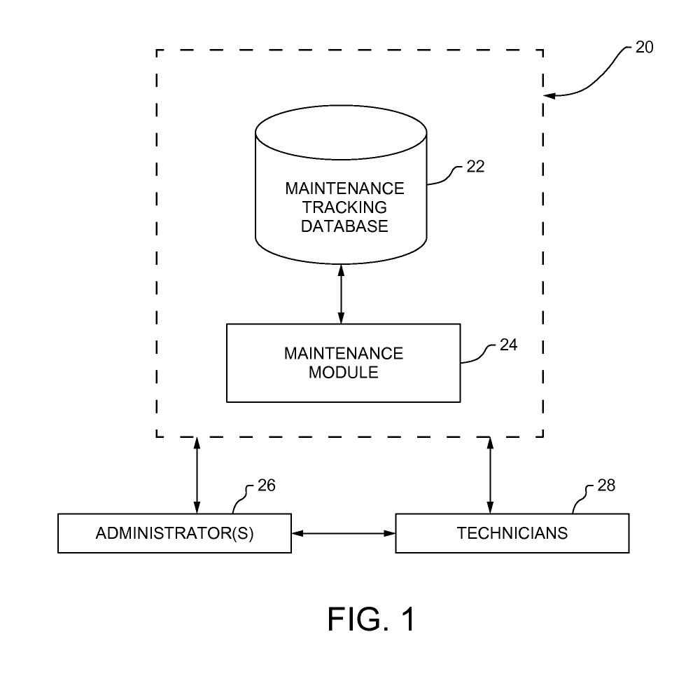

Referring now to the drawings, and with specific reference to FIG. 1 a schematic representation of a maintenance tracking system 20 is shown, in accordance with certain embodiments of the present disclosure. The maintenance tracking system 20 may include an electronic maintenance tracking database 22 coupled to a maintenance module 24. The maintenance module 24 may be configured to track and assign maintenance services for a fleet of machines. One or more administrators 26 and one or more technicians 28 may communicate with the maintenance tracking system 20, as well as between each other.

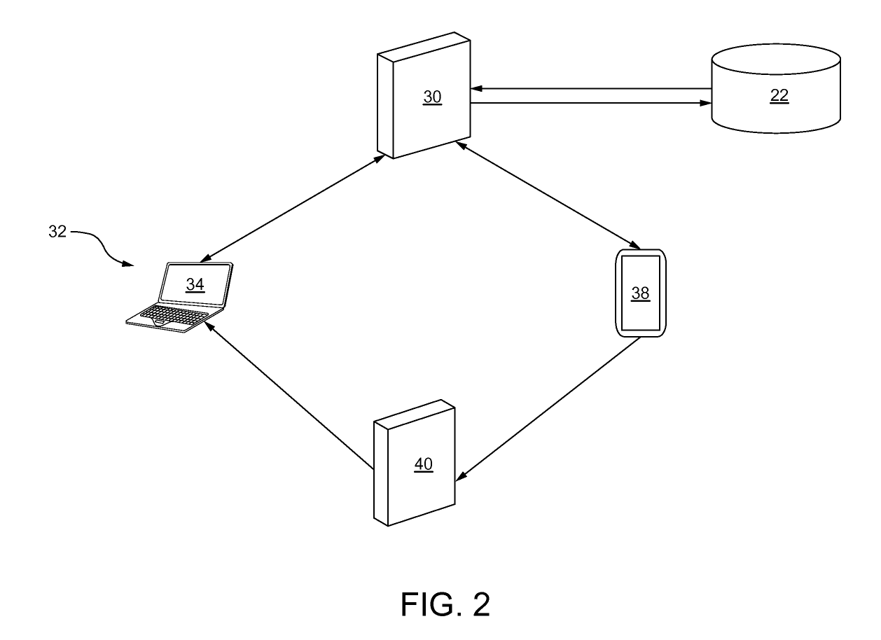

Referring now to FIG. 2, with continued reference to FIG. 1, one example for an architectural layout of the maintenance tracking system 20 is illustrated in FIG. 2, in accordance with another embodiment of the present disclosure. The maintenance tracking system 20 may comprise a server 30 coupled to the maintenance tracking database 22 and a maintenance services generator 32. Using the maintenance module 24, the maintenance services generator 32 may provide inputs to create and store a tracking list of maintenance services and inspections, along with associated data thereto, in the maintenance tracking database 22. For instance, the maintenance services generator 32 may be loaded on a first computing device 34 associated with a user or an administrator. However, more than one first computing device associated with multiple administrators may execute the maintenance services generator 32. In addition, the first computing device 34 may communicate with the server 30 to access, modify, and use the maintenance tracking database 22.

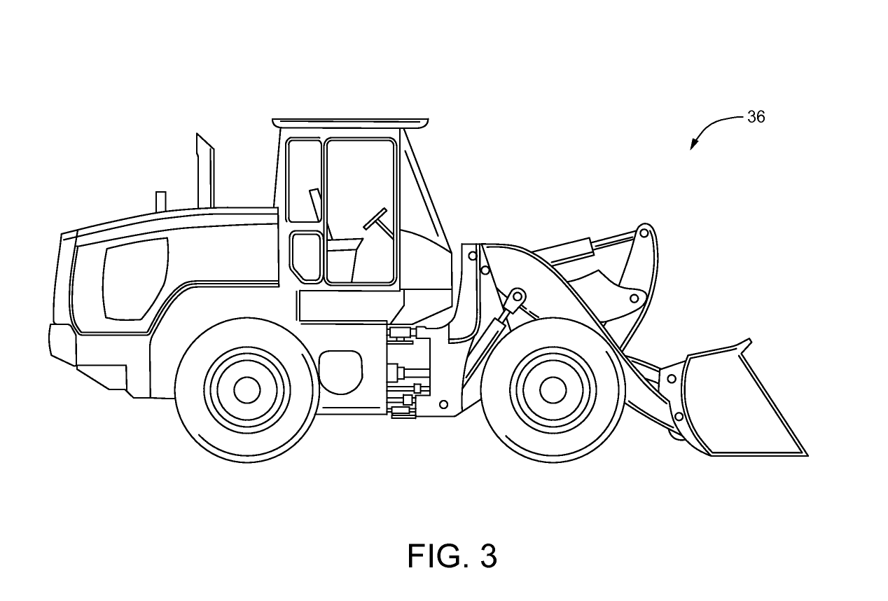

In an example, the maintenance services generator 32 may create a timeline of maintenance services and inspections for a fleet of machines. An example of a machine 36 that may be part of the fleet of machines is shown in FIG. 3. Although the machine 36 is illustrated as a wheel loader, the machine 36 may be of any other type. As used herein, the term “machine” refers to a mobile machine that performs driven operation involving physical movement associated with a particular industry, such as, construction, landscaping, mining, forestry, transportation, agriculture, etc. Non-limiting examples of machines include commercial and industrial machines, such as, earth-moving vehicles, loaders, excavators, dozers, motor graders, tractors, trucks, backhoes, mining vehicles, on-highway vehicles, trains, agricultural equipment, material handling equipment, and other types of machines that operate in a work environment.

Referring back to FIG. 2, a second computing device 38 may selectively communicate with the server 30 to access, modify, and/or use the maintenance tracking database 22. The second computing device 38 may further communicate with the maintenance services generator 32, such as, through the server 30 or an email server 40. For example, the second computing device 38 may be a portable computing device, such as a handheld, remote device that operates using a portable power source, such as, a battery, and is associated with a technician. However, other configurations may be used.

Each of the server 30, the first computing device 34 and the second computing device 38 may include one or more of a processor, a microprocessor, and a processor-based device that may include or be associated with a non-transitory computer readable storage medium having stored thereon computer-executable instructions, or any other suitable means for electronically implementing the maintenance module 24. The server 30, the first computing device 34, and the second computing device 38 may be configured to operate according to predetermined algorithms or sets of instructions programmed or incorporated into a memory that is associated therewith or accessible thereto.

However, other hardware, software, firmware, and configurations may be used to implement the maintenance tracking system 20. Furthermore, the server 30, the first computing device 34 and the second computing device 38 may also include software and hardware networking components to allow communications to and from the server 30, the first computing device 34, and the second computing device 38. Such networking components may provide wireless or wired networking functionality.

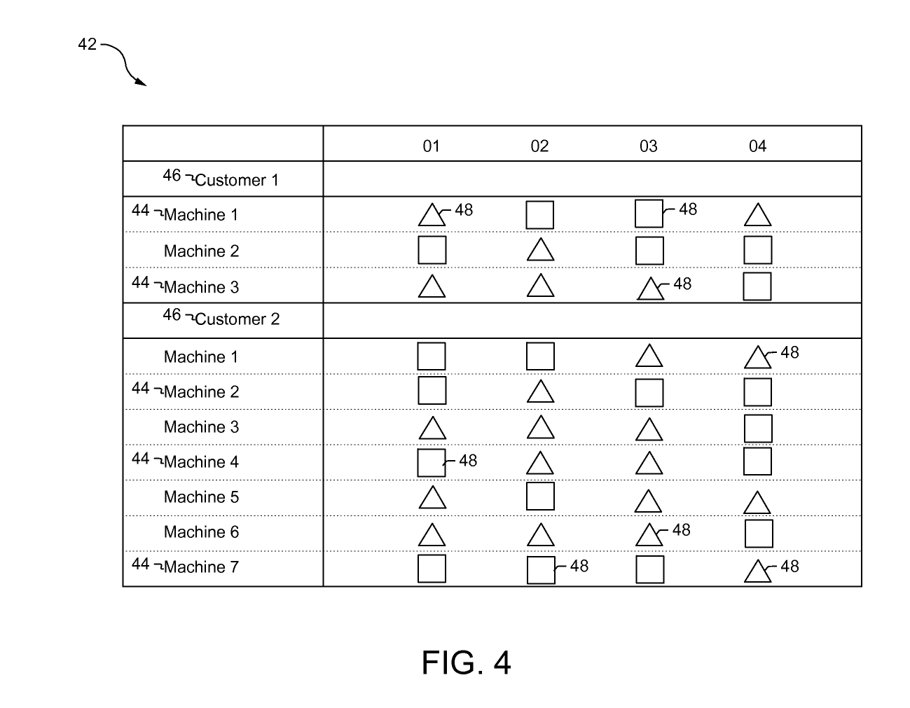

Turning now to FIG. 4, with continued reference to FIGS. 1-3, the maintenance module 24 may be configured to display the tracking list 42 stored in the maintenance tracking database 22 to the administrator via the first computing device 34, such as, in the form of a timeline. For example, the first computing device 34 may include a screen, or other type of user interface, to display the tracking list 42. The tracking list 42 may include various machine serial numbers 44 and customer identifications 46 for the fleet of machines. For each machine, the tracking list 42 may include various maintenance services 48 organized according to time periods for completion. For instance, the maintenance services 48 may include inspections or maintenance activities that have been completed, are overdue, and are upcoming.

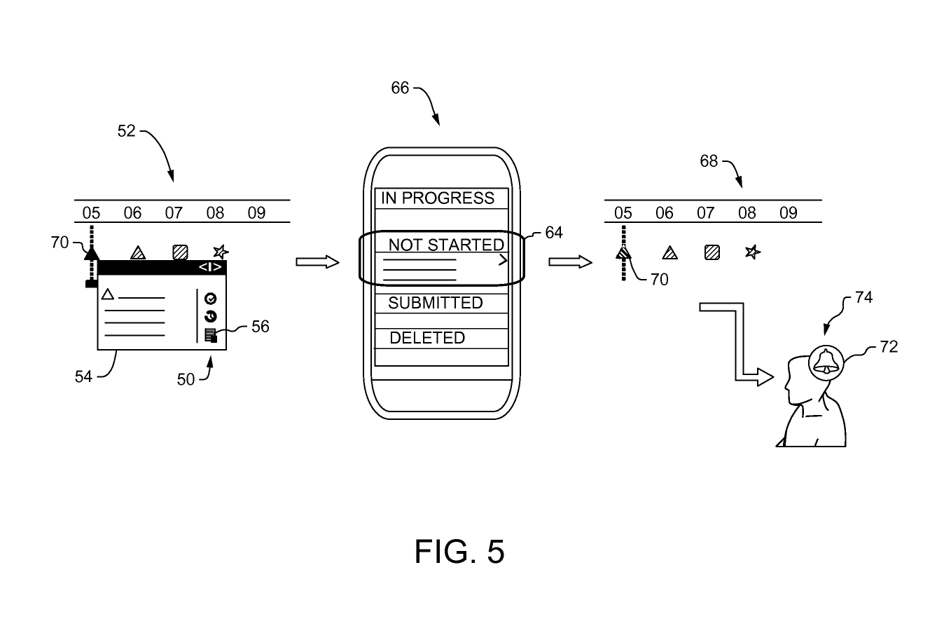

Referring now to FIG. 5, with continued reference to FIGS. 1-4, a flow diagram with example interfaces illustrating an assignment feature of the maintenance tracking system 20 is shown, in accordance with another embodiment of the present disclosure. For overdue or upcoming maintenance services, the maintenance module 24 may be configured to display an option 50 to assign the maintenance service in the tracking list 42 via the first computing device 34, such as, in interface 52. For example, when the administrator selects one of the maintenance services for one of the machines, information regarding the selected maintenance service may be presented in a pop-up display 54. The option 50 to assign the selected maintenance service for the selected machine may be included in the pop-up display 54, such as, through an assignment icon 56 or other visual representation.

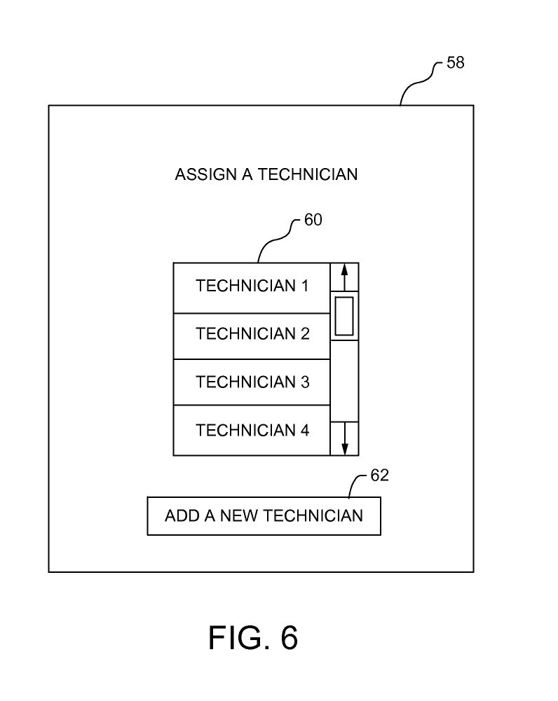

When the administrator selects the option 50 to assign the selected maintenance service, such as, by clicking on the assignment icon 56, the maintenance module 24 may be further configured to prompt the administrator to select a particular technician to complete the selected maintenance service. For instance, a prompt 58 to assign a technician, such as that shown in FIG. 6, may be displayed via the first computing device 34. The prompt 58 may include a list of technicians 60 for the administrator to choose from, as well as an option 62 to add a new technician not included in the list of technicians 60.

Once the administrator assigns a technician to complete the selected maintenance service on the selected machine, the maintenance module 24 may generate an updated tracking list 42 based on data associated with the selected technician in connection with the selected maintenance service for the selected machine. The updated tracking list 42 may be stored in the maintenance tracking database 22. Furthermore, data associated with the selected maintenance service and the selected machine may be captured and transmitted to the second computing device 38 associated with the selected technician.

For example, the maintenance module 24 may communicate data associated with the selected maintenance service and the selected machine to the second computing device 38 via a network, such as, a wireless network. The assigned technician may receive a notification 64 of the assignment on the second computing device 38, such as, in interface 66. The notification 64 may inform the assigned technician of the selected maintenance service to be completed on the selected machine. Furthermore, the data associated with the selected maintenance service and the selected machine may be displayed on the second computing device 38 when the technician chooses to view the notification 64.

More specifically, the data associated with the selected machine may include a machine serial number and a customer identification. The data associated with the selected maintenance service may include an inspection type, a maintenance activity, a due date, a list of machine parts needed to complete the selected maintenance service, and a checklist of steps for completing the selected maintenance service. However, other types of information may also be captured and communicated to the second computing device 38 associated with the selected technician.

In addition, the maintenance module 24 may be further configured to sync data input into the second computing device 38 with the maintenance tracking database 22. For instance, upon completion of the selected maintenance service for the selected machine, the second computing device 38 may receive input from the selected technician indicating completion of the assignment. Data indicating completion of the selected maintenance service may be communicated to the server 30, such as, by transmission via a wireless network. The maintenance module 24 may generate an updated tracking list based on the data indicating completion of the selected maintenance service for the selected machine.

The updated tracking list may then be stored in the maintenance tracking database 22. Furthermore, the maintenance module 24 may be configured to display the updated tracking list stored in the maintenance tracking database 22 to the administrator via the first computing device 34, such as, in the updated timeline of interface 68. In one example, an indication of the completed maintenance service may be displayed via a color scheme. For instance, an icon 70 for the selected maintenance service may be presented in a red color, such as in interface 52, when the maintenance service has yet to be completed. Upon completion of the maintenance service, the icon 70 may be presented in a green color, such as in interface 68. However, other configurations for displaying completed maintenance services may be used.

Moreover, upon receiving indication of the completed maintenance service, the maintenance module 24 may be further configured to notify the administrator. For example, the second computing device 38 may communicate completion of the selected maintenance via the email server 40, or other method. The maintenance module 24 may be configured to display a notification 72, such as in interface 74, to the administrator via the first computing device 34. When the administrator chooses to view the notification 72, a display including an indication of completion of the selected maintenance service for the selected machine may be presented via the first computing device 34. In addition, a reminder or a prompt to complete rationalization of future maintenance services for the selected machine may be displayed. In so doing, the administrator may rationalize or modify future maintenance services based on a completion date of the selected maintenance service.

### INDUSTRIAL APPLICABILITY

In general, the foregoing disclosure finds utility in various industrial applications, such as, in earthmoving, construction, industrial, agricultural, mining, transportation, and forestry machines. In particular, the disclosed system and methods may be used to assign maintenance services for earthmoving machines and other applications. More specifically, the foregoing disclosure provides a single electronic system and method that integrates assignment of maintenance services with maintenance service tracking of the fleet of machines.

By integrating the functions to track and assign maintenance services in one system, the disclosed system and method achieve significant time savings and overall efficient management of maintenance services. Additionally, the disclosed system and method supply an interface that combines administrator and technician activities into one fluid and visual timeline, thereby providing a complete representation of maintenance services for the fleet of machines. In so doing, the disclosed system and method increases maintenance tracking visibility and communication throughout the maintenance services timeline.

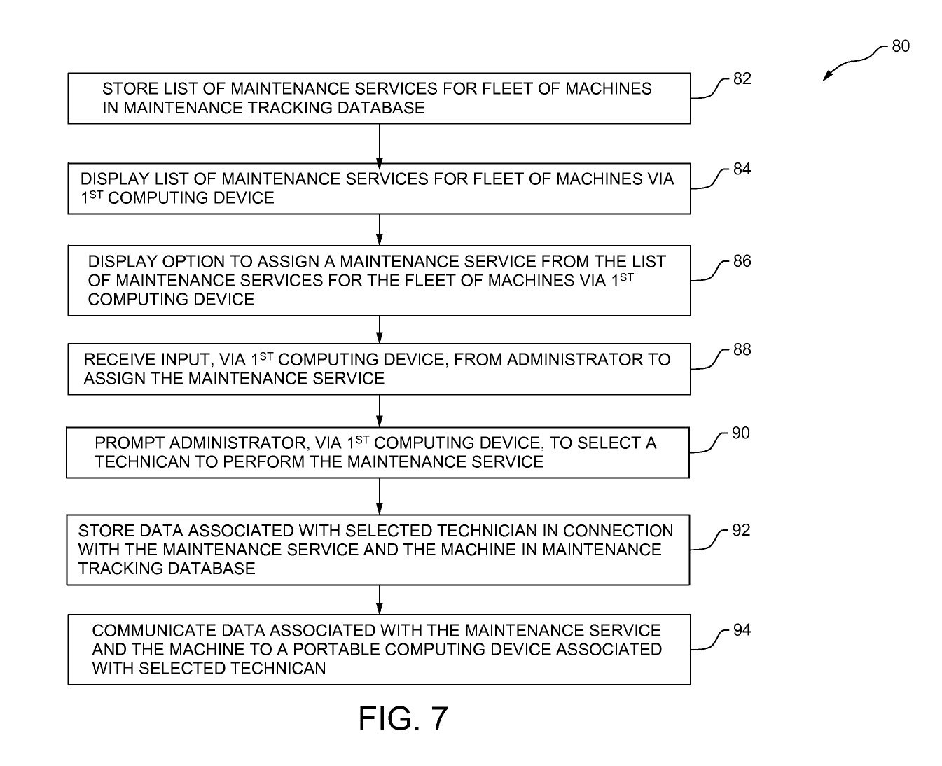

Turning now to FIG. 7, with continued reference to FIGS. 1-6, a flowchart illustrating an example process 80 for assigning maintenance services for a fleet of machines using a maintenance tracking computer server associated with an electronic maintenance tracking database is disclosed, in accordance with another embodiment. At block 82, a list of maintenance services for the fleet of machines may be stored in the electronic maintenance tracking database. At block 84, the list of maintenance services for the fleet of machines may be displayed via a computing device.

An option to assign a maintenance service from the list of maintenances services for the fleet of machines may be displayed via the computing device, at block 86. Input from an administrator to assign the maintenance service may be received via the computing device, at block 88. At block 90, the administrator may be prompted, via the computing device, to select a technician to perform the maintenance service. Data associated with the selected technician in connection with the maintenance service and the machine may be stored in the electronic maintenance tracking database, at block 92. At block 94, data associated with the maintenance service and the machine may be communicated to a portable computing device associated with the selected technician.

It is to be understood that the flowchart in FIG. 7 is shown and described as an example only to assist in disclosing the features of the disclosed system, and that more or less steps than that shown may be included in the processes corresponding to the various features described above for the disclosed system without departing from the scope of the disclosure.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A method of assigning maintenance services for a fleet of machines using a maintenance tracking computer server associated with an electronic maintenance tracking database, the method comprising:
storing a list of maintenance services for the fleet of machines in the electronic maintenance tracking database;
displaying, via a computing device, the list of maintenance services for the fleet of machines;
displaying, via the computing device, an option to assign a maintenance service for a machine;
receiving input from an administrator, via the computing device, to assign the maintenance service;
prompting the administrator, via the computing device, to select a technician to perform the maintenance service;
storing in the electronic maintenance tracking database data associated with the selected technician in connection with the maintenance service and the machine; and
communicating data associated with the maintenance service and the machine to a portable computing device associated with the selected technician.

2. The method of claim 1, further comprising receiving the data associated with the maintenance service and the machine on the portable computing device.

3. The method of claim 2, further comprising syncing data input into the portable computing device with the electronic maintenance tracking database.

4. The method of claim 3, further comprising receiving, via the portable computing device, input from the technician indicating the maintenance service on the machine is complete.

5. The method of claim 4, further comprising storing an indication of the completed maintenance service in the electronic maintenance tracking database.

6. The method of claim 5, further comprising updating the list of maintenance services for the fleet of machines in the electronic maintenance tracking database.

7. The method of claim 6, further comprising notifying the administrator of the completed maintenance service.

8. The method of claim 7, further comprising displaying, via the computing device, the indication of the completed maintenance service.

9. The method of claim 8, further comprising using a color scheme to display the indication of the completed maintenance service.

10. The method of claim 9, further comprising prompting the administrator to complete rationalization of future maintenance services for the machine.

11. A system of assigning maintenance services for a fleet of machines, comprising:
an electronic maintenance tracking database; and
a maintenance tracking computer server linked to the electronic maintenance tracking database, the maintenance tracking computer server including a processor configured via computer-executable instructions to:
store a list of maintenance services for the fleet of machines in the electronic maintenance tracking database,
display the list of maintenance services,
display an option to assign a selected maintenance service for a selected machine,
receive input from an administrator to assign the selected maintenance service,
display an option to assign a technician to complete the selected maintenance service upon receiving input from the administrator to assign the selected maintenance service,
receive input from the administrator indicating the assigned technician to complete the selected maintenance service for the selected machine,
store data associated with the assigned technician in connection with the selected maintenance service and the selected machine in the electronic maintenance tracking database,
transmit data associated with the selected maintenance service and the selected machine to a portable computing device associated with the assigned technician.

12. The system of claim 11, wherein the data associated with the selected machine includes at least one of a machine serial number and a customer identification.

13. The system of claim 11, wherein the data associated with the selected maintenance service includes at least one of an inspection type, a maintenance activity, a machine part, and a checklist.

14. The system of claim 11, wherein the processor is further configured to sync data from the portable computing device with the electronic maintenance tracking database.

15. The system of claim 14, wherein the processor is further configured to receive data indicating completion of the selected maintenance service from the portable computing device, generate an updated list of maintenances services for the fleet of machines based on the data indicating completion of the selected maintenance service, and store the updated list of maintenance services in the electronic maintenance tracking database.

16. The system of claim 15, wherein the processor is further configured to notify the administrator upon receipt of the data indicating completion of the selected maintenance service.

17. A method of assigning maintenance services for a fleet of machines using a maintenance tracking computer server associated with an electronic maintenance tracking database, the method comprising:
electronically writing a tracking list for the fleet of machines to the electronic maintenance tracking database, the tracking list including a plurality of maintenance services to be completed for each of the machines;
displaying the tracking list via a first computing device;
displaying an option to assign each of the maintenance services via the first computing device;
receiving input from an administrator to assign a selected maintenance service for a selected machine via the first computing device;
displaying a prompt to the administrator, via the first computing device, to select a technician to complete the selected maintenance service for the selected machine;
receiving from the administrator, via the first computing device, data associated with the selected technician to complete the selected maintenance service for the selected machine;
generating an updated tracking list based on the data associated with the selected technician in connection with the selected maintenance service for the selected machine;
storing the updated tracking list in the electronic maintenance tracking database; and
transmitting data associated with the selected maintenance service and the selected machine to a second computing device associated with the selected technician.

18. The method of claim 17, further comprising:
receiving the data associated with the selected maintenance service and the selected machine via the second computing device, and
displaying the data associated with the selected maintenance service and the selected machine via the second computing device.

19. The method of claim 18, further comprising:
receiving from the selected technician, via the second computing device, data indicating completion of the selected maintenance service;
generating an updated tracking list based on the data indicating completion of the selected maintenance service; and
storing the updated tracking list in the electronic maintenance tracking database.

20. The method of claim 19, further comprising:
transmitting the data indicating completion of the selected maintenance service to the first computing device; and
displaying the data indicating completion of the selected maintenance service via the first computing device.
